(19) United States
(12) Patent Application Publication
(10) Pub. No.: US 2017/0157619 A1
(43) Pub. Date: Jun. 8, 2017

(54) DEVICE FOR FIXING AND ALIGNING CUTTER BLADES FOR A SYSTEM FOR FINE COMMINUTION

(71) Applicant: ASTOR SCHNEIDWERKZEUGE GMBH, Storkow (DE)

(72) Inventors: Wolfram Schnäckel, Südharz OT Stolberg (DE); Ingo Micklisch, Halle (Saale) (DE); Matthias Fleischhauer, Steinhöfel (DE); Hans-Dieter Prawatky, Berlin (DE)

(21) Appl. No.: 15/325,744

(22) PCT Filed: Jul. 13, 2015
(86) PCT No.: PCT/EP2015/065947

§ 371 Date: Jan. 12, 2017

(30) Foreign Application Priority Data
Jul. 17, 2014 (DE) 10 2014 010 637.3
Aug. 13, 2014 (DE) 10 2014 012 065.1

(51) Int. Cl. B02C 18/06; B02C 18/20; B02C 18/00

(52) U.S. Cl. CPC B02C 18/06; B02C 18/00; B02C 18/20

(57) ABSTRACT

The invention relates to a device for fixing and aligning cutter blades for a system for fine comminution and/or for emulsification of semisolid, plastic or plastoelastic substances, in particular raw substances for food production, comprising means for the detachable fastening of the cutter blades (3) to a cutter drive shaft (4). Furthermore, according to the invention, a single-part or multi-part support or carrier body (6) is provided which extends under or over the cutter blades (3) and which is connected, radially at the inside, to the cutter drive shaft (4), wherein a positively locking and/or non-positively locking connection is formed at least radially at the outside between the associated end of the support or carrier body (6) and the respective cutter blade (3).

The invention relates to a device for fixing and aligning cutter blades for a system for fine comminution and/or for emulsification of semi-solid, plastic or plastoelastic substances, in particular roar substances for food production, comprising means for the detachable fastening of the cutter blades to a cutter drive shaft according to the preamble of claim 1.

A device for mounting several cutter blades is known from the prior art from DE 20 2005 000 892 U1, wherein two cutter blades are respectively fastened in a diametrically opposite manner to a receiving disc. The receiving discs are connected in a rotationally fixed manner to a polygonal shaft. The cutter blades attached to one of the receiving discs each comprise a front face which extends in an inclined manner in the axial direction of the polygonal shaft, which front faces are disposed opposite of each other and are formed as support surfaces for the cutter blades. The front faces rest against each other under a pretension in the mounted state of the cutter blades. These measures are intended to reduce the natural vibrations and reduce centrifugal forces during the operation of such a cutter.

A fastening device for cutting blades is known from AT 348 364. In this case too, two cutter blades are connected offset by 180° between the spacer rings by means of two fastening screws. The solution known from the prior art allows a readjustment of the blades that can be carried out independently from each other in the radial direction, namely through a slotted hole arrangement. The slotted hole is disposed in the spacer ring in such a way that the axis of the slotted hole is situated at an acute angle in relation to the circumferential direction, and the screw used for fixing penetrates the slotted hole and is provided with a clamping nut which by shifting the screw in the slotted hole can be brought into contact with a flat side of an inner edge of the blade receiver.

DE 868 703 discloses a cutter with blades which are arranged on a revolving shaft and which also engage in a revolving bowl. The cutter bowl forms an annular depression whose cross-section is a circular section. As is well known, the cutter blades then show their greatest efficiency if they move as closely as possible along the circular line which delimits the depression cross-section of the bowl.

According to DE 868 703, the cutter blades are preferably symmetrically attached to a common carrier of random shape in an arrangement which is substantially balanced on all sides, such that their cutting edges are disposed in a plane, preferably in a vertical plane placed through a diameter of the cutter bowl. The blades are no longer directly fastened to the shaft, but to a carrier which on its part is in connection with the shaft.

The generic DE 1 884 570 discloses a cutter with controllable or variable cutting processes, even when the machine runs. The device there allows controlling the cutting processes during operation or when the machine runs in a continuous manner with movable blades, which occurs by actuating an adjusting apparatus, e.g. in form of a handwheel. Several rotatably mounted blades whose cutting angle is adjustable are disposed in this respect to the end of a blade head. If the cutting edges of the blades there are directed with their cutting angle or angle of attack against further, non-adjustable cutter blades, the blades will operate in a sucking manner and will allow the material to be treated to flow in a free and rapid manner through the cutter blades in the blade head.

If the movable blades are set to an opposing cutting angle, i.e. the blade protrudes from the knife head, they will push back the raw material, especially a meat mass. This leads to a pileup and filling of the blade space, thus producing an artificial, closer cutting space.

Since all cutting angles disposed in between can be set, the desired and more or less greater piling up and the respectively most appropriate cutting and processing method for each type of meat processing can be selected for every sausage meat.

The adjustability of the blades according to DE 1 884 570 occurs by means of a push rod which is mounted in a hollow blade shaft. The push rod can be moved by a lever for setting the blade or cutting angle. The cutting angle of the blades can be set in a range of +6° to −6° degrees for example.

As is known, the production of fine masses such as fine sausage meat or pastes occurs in cutter machines of the type described above. Blades are arranged and centrally fixed on a rotating shaft, which blades protrude into a cutter container and comminute the respective product in the container.

In known cutter machines, the blades rotate in a similarly rotating bowl, wherein the blade and bowl rotation are disposed at a quasi-right angle with respect to each other. It is thus possible to continuously transport product to be comminuted into the region of the rapidly rotating blades.

As a result of the rotation of the bowl, a very strong lateral pressure acts during the immersion of the rotating blades into the product, which leads to an undesirable deflection of the blades, especially also in a solution according to DE 1 884 570. If one assumes that the rotational speed of the rotating blades is usually several 1000 rpm, then this also means a very large number of deflections of the blades per minute. This leads to tensions in the cutter blades, which in the end leads to blade breakages as a result of material fatigue.

It has been attempted until now to solve the aforementioned problem by limiting the bowl radius and thus also the blade radius and by limiting the rotational speed of the bowl.

For the purpose of optimal comminution and/or emulsification, the respective comminution system must be adjusted to the raw material concerning the comminution conditions. This relates especially to the number of blades and the rotational speed of the cutter bowl, but also to the angle of incidence of the cutting edges of the blades on the product and the actual cutting angle. Angle of incidence and cutting angle are currently varied in such a way that depending on the product different shapes of blades or different grinding angles are used.

A frequent change of blades leads to undesirable losses of time and productivity. The non-exchange of the blades for different products on the other hand occurs at the expense of quality and yield as well as profitability.

A further disadvantage of conventional cutters is due to the fact that the transport of the material to be comminuted through the blade region is essentially exclusively produced by the rotational movement of the cutter bowl. The blade system is only involved to a minor extent in this movement. The blades act with their lateral surface rather as a resistance to the product stream, thus leading to a very high energy input for the necessary movement of the cutter bowl.

On the basis of the statements made above, it is therefore the object of the invention to provide a further developed device for fixing and aligning cutter blades for a system for fine comminution which reduces the likelihood of fatigue and breakage of the employed cutter blades and which is capable, in a simple and individual manner, to cater to special recipes and properties of the substances to be treated, so that economical operation of cutters which contain the device to be created is enabled.

This object of the invention is achieved by a device for fixing and aligning cutter blades for a system for the fine comminution according to the combination of features according to claim 1, wherein the dependent claims at least represent appropriate embodiments and further developments.

A device is therefore assumed for fixing and aligning cutter blades for a system for the fine comminution and/or for the emulsification of semisolid, plastic or plastoelastic substances, in particular raw substances for food production. These can concern raw substances such as meat or fish, but also fruit, vegetables or the like. The device comprises means for the releasable fastening of generally known cutter blades to a cutter drive shaft. As is known, this fastening can occur via clamping and spacer rings by bolting or clamping, wherein obviously the possibility of radial adjustment of the blades as known from the prior art is maintained and ensured.

In accordance with the invention, a single-part or multi-part support or carrier body is provided which extends under or over the cutter blades.

The single-part or multi-part support or carrier body is connected radially at the inside to the cutter drive shaft, wherein an interlocking and/or friction-locked connection is formed at least radially at the outside between the respective end of the support or carrier body and the respective cutter blade.

As a result of the multiple fixing, especially double fixing, of the cutter blades, the lateral deflection of the blades with increased likelihood of breakage which is given in the prior art is virtually excluded.

The fixing of the blades can occur centrally/tangentially, centrally/radially, radially/radially, but also radially/tangentially, on the support or carrier body.

The applied support or carrier body has a circular-shaped or circular-segment-shaped flat contour for example.

Furthermore, the support or carrier body can comprise support arms in one embodiment, wherein the support arms extend at an angle to the plane of the support or carrier body and engage with their free ends in respective recesses radially on the outside in the respective cutter blade.

In a first embodiment, the engagement region between the respective recess and the free end of the respective support arm is formed as a pivot or swivel point for setting different angles of attack of the cutter blades with respect to the longitudinal axis of the drive shaft.

In a second embodiment, the cutter blades are mounted in a rotationally fixed manner, but also pivotably movable about their longitudinal axis, in the region of the fastening on the drive shaft, wherein the resulting angular variance is relative to the longitudinal axis of the drive shaft and the thus resulting different position of the radially outer end of the respective cutter blade can be set or fixed via interlocking elements between the respective cutter blade and the respective support arm.

The ends on the radially outer side of the cutter blades are connected in the region on the radial outer side of an exemplary circular support body in a friction-locked manner to said body, especially bolted thereon.

The aforementioned annular support body comprises a central fastening surface in its centre of gravity and several connecting webs between said fastening surface and the actual circular ring.

The central fastening surface comprises a polygonal recess for example which corresponds to the contour of a cutter drive shaft which is also formed as a polygon.

The cutter blades are jointly connected with the support or carrier body in a rotationally fixed manner to the cutter drive shaft, but are adjustable about their own axis and/or to the longitudinal axis of the cutter drive shaft by maintaining the desired support function. An adjusting mechanism can be utilised in this case which is known from the technology of changing the pitch angle of a propeller in aircraft.

In a further embodiment of the invention, at least parts of the support or carrier body have a three-dimensional shape for influencing the conveying effect of the substance or product to be comminuted. A spherical form for example provides the possibility to convey the raw substance to be treated in the manner of a turbine in order to increase product throughput.

In a preferred embodiment, the cutter blades have the shape of a circular arc, wherein the start and end of the circular arc are connected to the respective support or carrier body in an interlocking and/or friction-locked manner.

In this respect, the region of the support or carrier body to be connected to the drive shaft in a rotationally fixed manner can comprise means which allow pivoting of the support or carrier body so that it can also assume an angular configuration which deviates from the right angle relative to the longitudinal axis of the drive shaft.

The invention will be explained below in closer detail by reference to embodiments shown in the drawings, wherein:

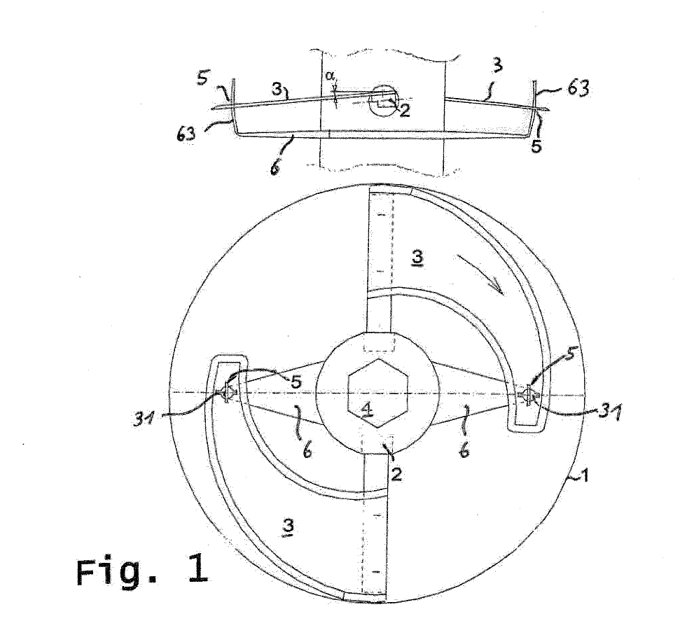

FIG. 1 shows a side view and a top view of a first embodiment of the invention with a cutter blade fastening in the front region in an interlocking manner to a respectively profiled support body;

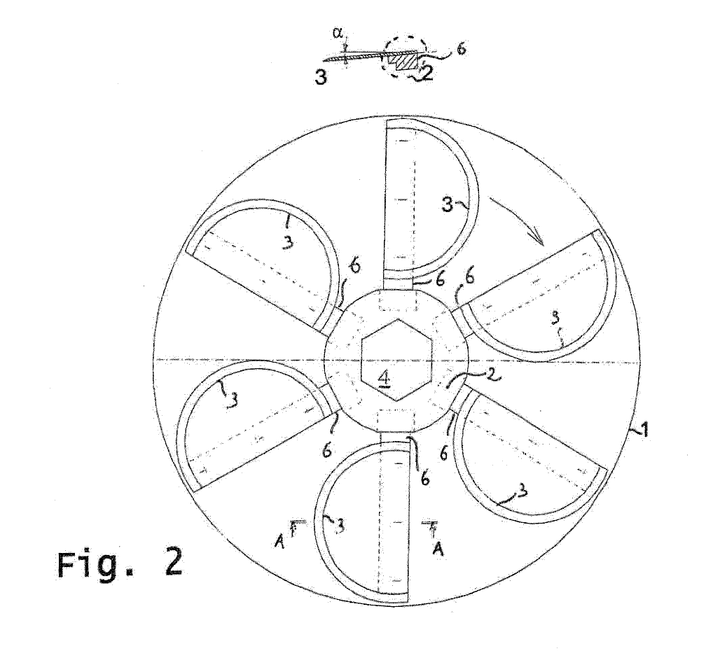

FIG. 2 shows a blade arrangement with support body and a sectional view along the line A-A, wherein the support body with the cutter blades are formed to be jointly angularly adjustable, and

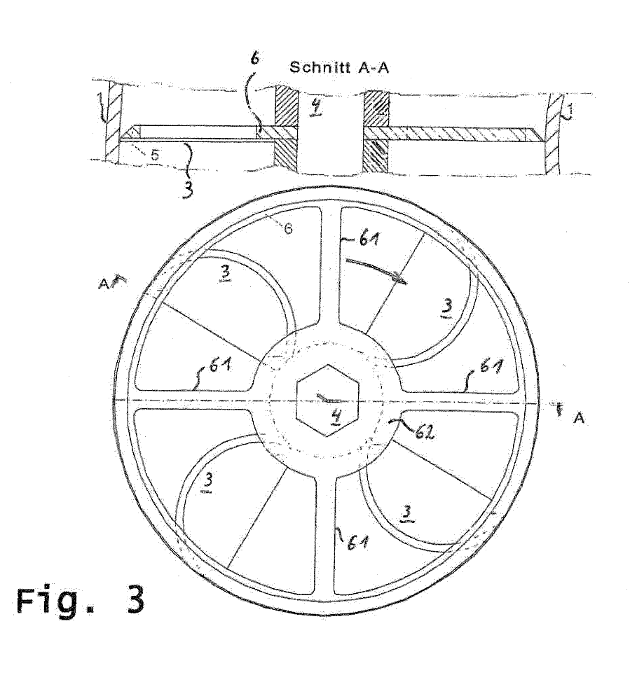

FIG. 3 shows a top view of a cutter blade arrangement with annular support or carrier body as well as a sectional view along the line A-A with a bolted connection of the respective ends of the cutter blades to the annular support or carrier body.

It is a common feature in the following embodiments that the cutter blades are fixed twice in order to avoid lateral deflection of the blades, but at least to reduce said deflection. As a result of a variable inclined position of the cutter blades, the angle of attack of the respective cutter blade on the product to be treated as well as the cutting angle can be varied specific to the product. This renders an exchange of blades in the case of a respective change of the starting product to be treated substantially unnecessary. Furthermore, the product flow in the bowl is supported via the inclined position of the cutter blades. This can additionally be produced in such a way that the blade bodies themselves do not have a flat shape but a suitable three-dimensional shape in order to produce a turbine effect with a respective conveying effect. The dwell time of the product in the cutting space is reduced or becomes controllable in this manner so that the energy consumption for driving the cutter bowl can be reduced. In addition to the shape of the cutter blades, the shape of the respective support or carrier body can also have a positive influence on the desired conveying effect on the product.

The user is given the possibility by means of the solution in accordance with the invention to change the geometric arrangement of the blades and to adjust said arrangement to the product to be treated, so that influence can be made on the quality and quantity of the fine comminution on site. A further advantage that needs to be stressed concerning the use of the support or carrier body is the fact that with the multiple fastening of the blades to the carrier system the cutter blades themselves can be formed in a simpler and more cost-effective way, which represents a considerable advantage of the invention in addition to reducing the risk of breakage of the blades.

In the illustration according to FIG. 1, the region of the cutter bowl 1 which is not shown in closer detail is designated with the reference numeral 1. The actual comminution device protrudes into the cutter bowl 1, which comminution device comprises a blade drive shaft 4 which has a hexagonal cross-section for example.

The upper illustration of FIG. 1 further shows the support arms 63, which extend angularly to the support or carrier body 6.

The support arms 63 engage in respective recesses 31 in the respective blade 3.

The recesses 31 are introduced in the respective blade ends radially on the outside.

Several blades 3, which are usually arranged as opposite pairs, are connected in a rotationally fixed manner to the blade drive shaft 4.

The blades 3 are supported in accordance with the invention by a carrier body 6, which acts in this respect as a support body.

An angular adjustability (angle α) is indicated in FIG. 1 in the upper illustration in the region of a blade receptacle 2 which is radially on the inside.

A blade receptacle 5, which is disposed radially on the outside, is formed in such a way that different engaging means are provided which allow the fixing of the different blade angles α.

The comminution device according to FIG. 2 is based on a cutter bowl 1 into which the actual comminution device reaches, which comprises the drive shaft 4 with a plurality of blades 3.

Carrier bodies 6, which are arranged in a radiating manner relative to the drive shaft 4, each accommodate one drive blade 3.

Fixing of the drive blades 3, which are formed in the manner of an arc for example, occurs several times relating to the carrier body 6.

The carrier body 6 is formed in an angularly adjustable manner in the region of the blade receptacle 2, so that an adjusting angle a of the blades 3 can also be realised in this embodiment.

In the embodiment according to FIG. 3, an annular carrier body, i.e. a carrier ring 6, is provided.

The carrier ring 6 is connected via webs 61 to a central fastening surface 62.

In this embodiment too, advantageously arc-shaped blades 3 can be used, which are bolted together with the carrier ring 6 in the region of the front blade receptacle 5, i.e. radially at the outside.

The carrier ring 6 (see sectional view along the line A-A according to FIG. 1, upper illustration) can be provided with a shape which is capable of conveying the raw substance to be comminuted in order to increase throughput of the product and reduce the treatment time. In FIG. 3, upper illustration, the region of the cutter bowl is again provided with the reference numeral 1. It is further possible to influence the result of the comminution via an offset of the blades 3.

1. A device for fixing and aligning cutter blades for a system for fine comminution and/or emulsification of semisolid, plastic or plastoelastic substances, in particular raw substances for food production, comprising means for the detachable fastening of the cutter blades (3) to a cutter drive shaft (4), characterized in that a single-part or multi-part support or carrier body (6) is provided, which extends under or over the cutter blades (3) and which is connected, radially at the inside, to the cutter drive shaft (4), wherein an interlocking and/or friction-locked connection is formed at least radially at the outside between the respective end of the support or carrier body (6) and the respective cutter blade (3).

2. A device according to claim 1, characterized in that the support or carrier body has an annular or circular-segment-like flat shape.

3. A device according to claim 1, characterized in that the support or carrier body (6) comprises support arms (63), wherein the support arms (63) extend at an angle to the plane of the support or carrier body (6) and engage with their free ends into respective recesses (31) radially at the outside in the respective cutter blade (3).

4. A device according to claim 3, characterized in that the engagement region between the respective recess (31) and the respective free end of the respective support arm (63) is formed as a pivot or swivel point for setting different pitch angles of the cutter blades (3) with respect to the longitudinal axis of the drive shaft (4).

5. A device according to claim 3, characterized in that the cutter blades (3) are mounted in a rotationally fixed manner in the region of their fastening to the drive shaft (4), but are mounted in a pivotably movable manner about their longitudinal axis, wherein the resulting angular variance relative to the longitudinal axis of the drive shaft and the resulting different position of the end radially at the outside of the respective cutter blade can be set or fixed via interlocking elements between the respective cutter blade and the respective support arm.

6. A device according to claim 2, characterized in that the ends of the cutter blades (3) radially at the outside are connected in the region radially at the outside of an annular carrier body (6) in a friction-locked manner, especially bolted together therewith.

7. A device according to claim 6, characterized in that the annular carrier body (6) comprises a central fastening surface (62) disposed in its centre of gravity and several connecting webs (61) between the fastening surface (62) and the circular ring.

8. A device according to claim 7, characterized in that the central fastening surface (62) comprises a polygonal recess which corresponds to the contour of a cutter drive shaft (4) formed as a polygon.

9. A device according to claim 1, characterized in that the cutter blades (3), together with the support or carrier body (6), are in connection in a rotationally fixed manner with the cutter drive shaft (4), but are adjustable about their own axis and/or to the longitudinal axis of the cutter drive shaft (4) by maintaining the support function.

10. A device according to claim 1, characterized in that the support or carrier body (6), or parts thereof, have a three-dimensional shape for influencing the conveying effect on the substance or product to be comminuted.

11. A device according to claim 1, characterized in that the cutter blades (3) are arc-shaped, wherein both the start and end of the respective arc are connected in an interlocking and/or friction-locked manner to the respective support or carrier body (6).

12. A device according to claim 1, characterized in that the support or carrier body (6), including the cutter blades (3), are disposed in a bowl-shaped receiving container.

13. A device according to claim 1, characterized in that the support or carrier body (6), including the cutter blades (3), are disposed in a tube of a continuous cutter.

14. A device according to claim 1, characterized in that several support or carrier bodies (6), including the cutter blades (3), are arranged one behind the other in the direction of movement of the material to be comminuted.
